(19) United States
(12) Patent Application Publication
(10) Pub. No.: US 2013/0211877 A1
(43) Pub. Date: Aug. 15, 2013

(54) RETAIL PRODUCT PRICING MARKDOWN SYSTEM

(71) Applicant: ORACLE INTERNATIONAL CORPORATION, (US)

(72) Inventors: Alex KUSHKULEY, Acton, MA (US); Su-Ming WU, Waltham, MA (US)

(73) Assignee: ORACLE INTERNATIONAL CORPORATION, Redwood Shores, CA (US)

(21) Appl. No.: 13/645,722

(22) Filed: Oct. 5, 2012

Related U.S. Application Data
(60) Provisional application No. 61/598,028, filed on Feb. 13, 2012.

(51) Int. Cl. G06Q 30/02

(52) U.S. Cl. 705/7.31

(57) ABSTRACT

A system that determines a pricing markdown schedule for a retail item at a store receives demand parameters of the retail item at the store and one or more constraints, and expresses a price curve and inventory curve as linear combinations of price and inventory coefficients for orthogonal polynomials. The system determines revenue in terms of values of the price and inventory coefficients, determines an initial guess of the price and inventory coefficients, and determines a gradient of the revenue. The system then maximizes the revenue based on the revenue, the initial guesses, the gradient, and the constraints, where the constraints are in terms of the price and inventory coefficients. Based on the maximized revenue, the system then generates the price markdown schedule.

### CROSS REFERENCE TO RELATED APPLICATIONS

This application claims priority of Provisional Application Ser. No. 61/598,028, filed on Feb. 13, 2012, the contents of which is hereby incorporated by reference.

### FIELD

One embodiment is directed generally to a computer system for determining product pricing, and in particular to a computer system that determines retail product pricing markdowns.

### BACKGROUND INFORMATION

For a retailer or any seller of products, at some point during the selling cycle a determination will likely need to be made on when to markdown the price of a product, and how much of a markdown to take. Price markdowns can be an essential part of the merchandise item lifecycle pricing. A typical retailer has between 20% and 50% of the items marked down (i.e., permanently discounted) and generates about 30-40% of the revenue at marked-down prices.

A determination of an optimized pricing markdown maximizes the revenue by taking into account inventory constraints and demand dependence on time period, price and inventory effects. An optimized markdown can bring inventory to a desired level, not only during the full-price selling period, but also during price-break sales, and maximize total gross margin dollars over the entire product lifecycle.

### SUMMARY

One embodiment is a system that determines a pricing markdown schedule for a retail item at a store. The system receives demand parameters of the retail item at the store and one or more constraints, and expresses a price curve and inventory curve as linear combinations of price and inventory coefficients for orthogonal polynomials. The system determines revenue in terms of values of the price and inventory coefficients, determines an initial guess of the price and inventory coefficients, and determines a gradient of the revenue. The system then maximizes the revenue based on the revenue, the initial guesses, the gradient, and the constraints, where the constraints are in terms of the price and inventory coefficients. Based on the maximized revenue, the system then generates the price markdown schedule.

### BRIEF DESCRIPTION OF THE DRAWINGS

FIG. 1 is a block diagram of a computer system that can implement an embodiment of the present invention.

FIG. 2 is a flow diagram of the functionality of the pricing markdown module of FIG. 1 when determining a retail product pricing markdown in accordance with one embodiment.

### DETAILED DESCRIPTION

One embodiment is a retail product pricing markdown system that determines markdown pricing for a retailer that maximizes revenue while taking into account an inventory effect. Embodiments use a “direct method” rather than an “analytical” method by expressing price and inventory curves in terms of polynomials.

In one embodiment, pricing markdown can be determined by solving a “markdown optimization problem.” The objective of the markdown optimization problem can be to find a monotonically decreasing sequence of merchandise prices that maximizes the revenue by taking into account inventory constraints and demand dependence on time period, price and inventory effects.

The mathematical formulation of the markdown optimization problem can be defined in one embodiment as:

$$max {\sum }_{t = 1}^{T} {p}_{t} {s}_{t}$$

subject to:

sₜ≦dₜ(I₀,p₁, . . . ,pₜ,d₁, . . . ,dₜ₋₁) ∀t=1, . . . ,T

sₜ≦Iₜ₋₁

Iₜ=Iₜ₋₁−sₜ

where:
T is the length of the markdown period, usually measured in weeks;
sₜ is the sales volume in period t;
pₜ is the sales price at period t, which is the decision variable;
Iₜ is the inventory level at the end of time period t, I₀ is given as part of the input; and
dₜ( . . . ) is the demand, which in general is a function of past and present price settings, initial inventory, and demand in previous periods. The objective of the optimization problem is to maximize the total revenue.

In one known pricing markdown optimizer, “Retail Markdown Optimization (MDO)”, version 13.2, from Oracle Corp., a number of simplifying assumptions are made regarding the demand to solve the markdown optimization problem, which results in the following expression for the demand function:

d(t,p,I)=kdₚ(p)d_{I}(I)s(t)δ(t)=k(p/p_{f})^{γ}(I/Iₚ)^{α}s(t)δ(t);

where the components of the demand function are as follows:

Price Effect, dₚ(p): captures the sensitivity of demand to price changes. It is modeled as an isoelastic function of price p with constant elasticity γ<−1, dₚ(p)=(p/p_{f})^{γ} where p_{f} is the full price of the item;

Inventory Effect, d_{I}(I): also known as the “broken-assortment effect”, which occurs when willing-to-pay customers cannot find their sizes/colors. It is modeled as a power function of on-hand inventory I, d_{I}(I)=(I/I_{c})^{α}, where I_{c} is the critical inventory of the item;

Seasonality, s(t): seasonal variation of demand due to holidays and seasons of the year; shared by similar items;

Base demand, k: the scaling coefficient expressing the overall strength of the demand;

Random fluctuations, δ(t): random process expressing the stochastic nature of the consumer demand.

The demand model parameters are fitted by estimating base demand, k, price elasticity, γ, and inventory effect power, α, via regression on multiple sales data points with known price, inventory and seasonality. However, this demand model is based on an exhaustive search. Therefore, its implementation is typically impractical due to an exponential amount of calculations required at run time unless the number of planned markdown price changes is limited to two. However, this limitation makes it difficult or impractical to account for the inventory effect, which requires multiple price markdowns and therefore would require an enormous amount of calculations.

In contrast, in one embodiment of the present invention, a “direct method” approach expresses constraints as coefficients/variables to optimize markdown pricing while taking into account the inventory effect. The direct method approach implements approximation using orthogonal polynomials. In one embodiment, the orthogonal polynomials are “Chebyshev” polynomials. Chebyshev polynomials are a specific case of a general mathematical technique called “decomposition by orthogonal polynomials.” Approximation using Chebyshev polynomials is similar to approximation by Fourier series. Chebyshev approximation uses Chebyshev polynomials instead of the sines and cosines of Fourier series. In one embodiment, the demand functions and other functions are all approximated by a linear combination of Chebyshev polynomials. The approximation is better the more terms there are in the linear combination, however it is not necessary to use an enormous number of terms. The derivatives (and integrals) of a linear combination of Chebyshev polynomials is another linear combination of Chebyshev polynomials.

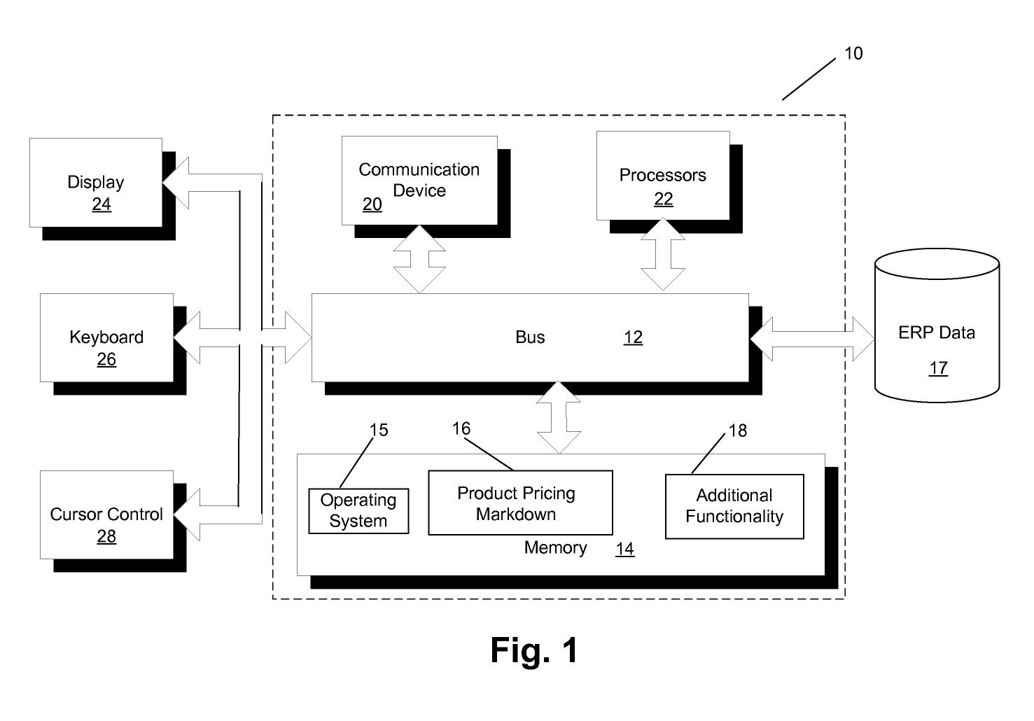

FIG. 1 is a block diagram of a computer system 10 that can implement an embodiment of the present invention. Although shown as a single system, the functionality of system 10 can be implemented as a distributed system. System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network or any other method.

Computer readable media may be any available media that can be accessed by processor 22 and includes both volatile and nonvolatile media, removable and non-removable media, and communication media. Communication media may include computer readable instructions, data structures, program modules or other data in a modulated data signal such as a carrier wave or other transport mechanism and includes any information delivery media.

Processor 22 is further coupled via bus 12 to a display 24, such as a Liquid Crystal Display (“LCD”), for displaying information to a user. A keyboard 26 and a cursor control device 28, such as a computer mouse, is further coupled to bus 12 to enable a user to interface with system 10.

In one embodiment, memory 14 stores software modules that provide functionality when executed by processor 22. The modules include an operating system 15 that provides operating system functionality for system 10. The modules further include a pricing markdown module 16 that determines a retail product pricing markdown schedule while accounting for inventory effects, as disclosed in more detail below. System 10 can be part of a larger system, such as an enterprise resource planning (“ERP”) system. Therefore, system 10 will typically include one or more additional functional modules 18 to include the additional functionality. A database 17 is coupled to bus 12 to provide centralized storage for modules 16 and 18 and store pricing data and ERP data such as inventory information, etc.

In general, a product markdown formula gives the total amount of revenue for an item M selling at a store S over a given period of time [T0, T1] (i.e., from time “T0” to time “T1”). The formula includes:
1. A price curve p(t), giving the price of M at S at each point in time. p(t) is typically given as a “relative price,” meaning the price of M is divided by its maximum price.
2. An inventory curve I(t), giving the inventory of M at S at each point in time. Typically, I(t) is given as a “relative inventory,” meaning the inventory of M divided by its maximum inventory.
3. The “base demand” K of M at S, is the “base rate” of sales, meaning the units sold in the absence of all other effects that might affect sales.
4. The “elasticity” γ (gamma) of M at S.
5. The “inventory effect” parameter α (alpha) of M at S.
6. The seasonality σₜ (sigma) of M at S.

If (1)-(6) above are all known, then revenue for M selling at S over [T0, T1], based on a standard approach to modeling revenue, is:

R=∫_{T}_{₀}^{T}^{₁}K·I^{α}p^{γ+1}σₜdt (1)

However, p(t) is usually not known; in particular, retailers want recommendations for how they should set the price of M at S in order to maximize revenue. Therefore, retailers want to know what p(t) should be, and systems for performing markdown recommendations such as embodiments of the present invention in general calculate what p(t) should be.

Therefore, one embodiment determines the price curve p(t) and inventory curve I(t) which maximizes the above revenue formula, meaning maximizes the total amount of revenue from T0 to T1. The maximization is performed after (3) through (6) above are known. Thus, the maximization will occur after known methods/procedures has been implemented to determine the quantities in (3)-(6) above. In general, embodiments implement the following functionality:
1. Determine the “demand parameters” (quantities named in (3)-(6) above). This can be done by any known method.
2. Maximize R. This is independent of how the demand parameters have been determined, and hence 1 and 2 are independent as long as 1 is done before 2. Determine the p(t) and I(t) that maximizes R.
3. On the basis of the calculated p(t), make markdown recommendations to the retailer.

Typically, there is also a constraint between price and inventory because the price at which something sells generally determines how quickly inventory is depleted. The same standard model of revenue above also gives the following as a standard constraint:

$$\frac{d I}{d t} = - K \cdot {I}^{α} {p}^{γ} {σ}_{t} \qquad ( 2 )$$

Therefore, embodiments determine the price curve and inventory curve that maximizes revenue subject to the above constraint. Other constraints are possible, and in fact the exact nature of the retailer's business will determine the exact form of this constraint.

In one embodiment, the possible price curves and possible inventory curves are expressed in terms of a fixed, finite set of coefficients/variables by using the Chebyshev approximation. In this way, the huge space of all possible price curves and all possible inventory curves is reduced to a small set of coefficients. The variables/coefficients in the Chebyshev approximation of the price curve are referred to as “pᵢ” and the variables/coefficients in the Chebyshev approximation of the inventory curve are referred to as “Iⱼ”. Thus, in one embodiment, to determine a price curve, it is only necessary to determine the coefficients pᵢ. Similarly for the inventory curve, it is only necessary to determine the coefficients Iⱼ.

In one embodiment, a relatively few pᵢ and Iⱼ coefficients are used. In one embodiment, 20 terms for the expansion is sufficient (i.e., p₁ through p₂₀, and I₁ through I₂₀.

Embodiments generate expressions for price and inventory in terms of the pᵢ and Iⱼ and orthogonal (e.g., Chebyshev) polynomials. These expressions for price curve and inventory curve are plugged into the above formula (1) for R. Now the formula for R depends only on pᵢ and Iⱼ, and thus the solution is finding values for pᵢ and Iⱼ that maximize R. This is relatively efficient because of the relatively small number of pᵢ and Iⱼ.

The maximization can be performed by known commercial software packages (e.g., the “JMSL™ Numerical Library for Java™ Applications” package from Rogue Wave Software, Inc.). These packages or solvers also require a formula for the gradient of R, which can be calculated from the above formula for R.

Maximization generally runs faster and gives better results if it is given a good initial guess for the pᵢ and Iⱼ coefficients. Maximization algorithms typically rely on having a good guess for the values of the coefficients. Otherwise the algorithm may not find an answer close to the true maximum.

For the initial guess, in one embodiment the pᵢ and Iⱼ coefficients are determined by fitting to historical prices and historical inventory. This assumes that the future optimal price and inventory curves will not be that far away from the historical ones, and therefore the maximization algorithm has a good chance of finding the maximum if the historical price and historical inventory is used as a guess.

The constraint on inventory and on price must also be entered into the maximization solver so that it will maximize R subject to the constraint. Because the constraint can involve the derivative of I, and because the derivatives (and integrals) of a linear combination of polynomials is another linear combination of polynomials, the constraint can be expressed as a set of constraints on the Iⱼ and pᵢ, as required by known maximization solvers. One embodiment handles the following types of equality constraints as follows:

“Point wise equality” constraints are constraints such as I(t) or p(t) equals specific values for a specific t. These constraints are handled by plugging the coefficients into the Chebyshev expansion. For example, for a constraint I(0)=100, t=0 is plugged into the Chebyshev expansion for I(t), and setting equal to 100. The result is a linear equality on the Iₜ. All point wise constraints are handled using this approach, which is referred to as “collocation”.

“Functional equality” constraints are constraints of the form F(I(t), p(t))=0, where F is some function of two coefficients. In one embodiment, these constraints are handled by performing a Taylor expansion G of F. Then G(I(t), p(t)) is a polynomial in I(t) and p(t). Based on the theory of orthogonal polynomials, to express G(I(t), p(t)) as Chebyshev polynomials, it is only necessary to determine the coefficient cⱼ of Chebyshev polynomial Cⱼ as:

cⱼ=∫_{T}_{₀}^{T}^{₁}G(I(t),p(t))·Cⱼ(t)dt

Because this integral is a function of pᵢ and Iᵢ, and thus cⱼ is a function of pᵢ and Iᵢ, it is only necessary to determine what this function is. Because the integrand consists of products of polynomials, the coefficients of which are expressions involving pᵢ and Iᵢ, the integration can be performed to eventually end up with simply an expression involving pᵢ and Iᵢ. This expression is then cⱼ. This procedure can then be performed for every Chebyshev polynomial Cⱼ, for 0≦j≦20. Once expressions for all of the cⱼ are obtained, by the theory of orthogonal polynomials, they can all be equated to 0, and these are the constraints on pᵢ and Iᵢ that are sought.

“Functional equality” constraints involving derivatives are constraints of the form F(I(t),p(t),dI/dt,dp/dt)=0, so that the derivatives of I and p are involved in the constraint. In one embodiment, these constraints are handle by differentiating I and p with respect to t, and obtaining polynomial expressions for the derivatives, since I and p are expressed as Chebyshev polynomials. Then, once again F can be expressed as a Taylor expansion, and as above proceed in a manner where no derivatives are involved.

In other embodiments, alternative approaches are used to handle functional equality constraints, both with and without derivatives. For example, instead of handling as disclosed above, embodiments merely apply collocation by expressing the functional inequality as a number of point-wise inequalities. This is possible because in an typical use, embodiments are concerned with a finite number of discrete weeks of data (e.g., 52 for an entire year). Over 52 weeks, a functional inequality translates into 52 point wise inequalities, that is, F(I(t),p(t),dI/dt,dp/dt)=0 for each t that is at the end of the week for one of the 52 weeks. Therefore, in one embodiment the 52 values are plugged in for t, and constraints (possibly non-linear) are gotten on the pᵢ and Iᵢ.

In one embodiment, a determination as to whether to use one approach or the other disclosed above may depend on which approach produces less complex constraints. For example, if the approach through Chebyshev coefficients produces constraints that are linear, and collocation produces non-linear ones, then collocation would be less preferable.

One embodiment handles the following types of inequality constraints as follows:

“Point wise inequality” constraints are similar to point-wise equality constraints, except with inequalities instead of equality. They are handled with collocation the same way as with equality constraints disclosed above, with the result being linear inequalities on the pᵢ and Iᵢ.

“Functional inequality” constraints are of the form F(I(t),p(t),dI/dt,dp/dt)≦0 or F(I(t),p(t),dI/dt,dp/dt)<0. For these constraints, collocation is the only possibility in one embodiment, because inequalities do not translate into inequalities on the cⱼ. Over 52 weeks, a functional inequality translates into 52 point wise inequalities, that is, F(I(t),p(t),dI/dt,dp/dt)<0 for each t that is at the end of the week for one of the 52 weeks.

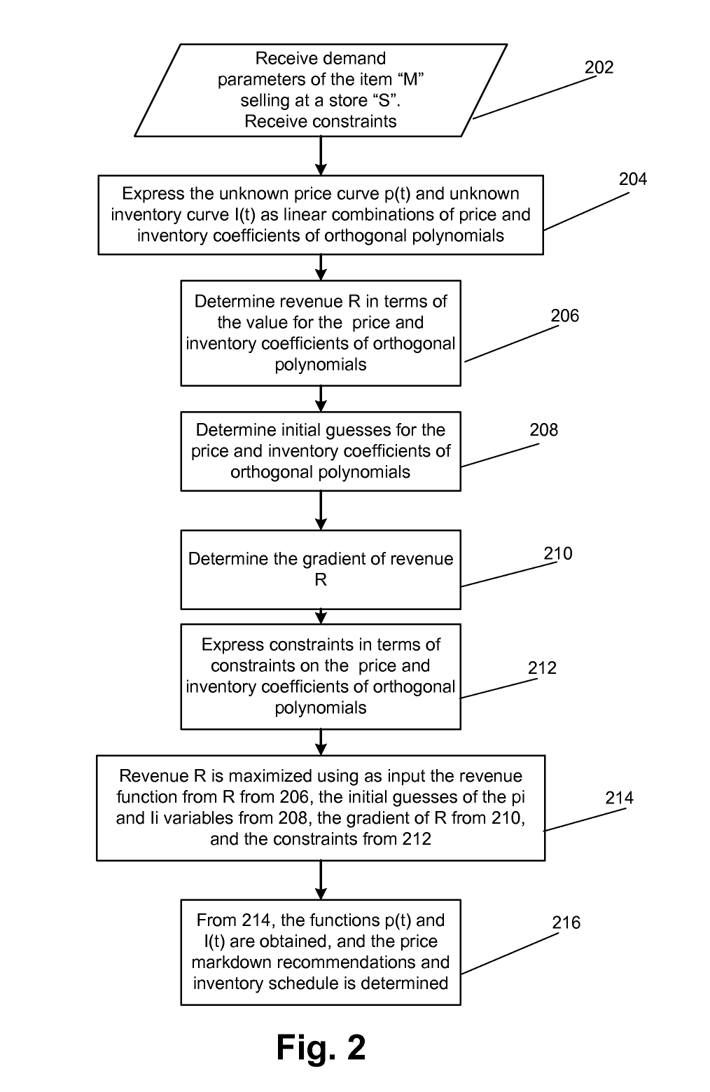

FIG. 2 is a flow diagram of the functionality of pricing markdown module 16 of FIG. 1 when determining a retail product pricing markdown in accordance with one embodiment. In one embodiment, the functionality of the flow diagram of FIG. 2 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software.

At 202, the “demand parameters” of the item “M” selling at a store “S” are received. As disclosed above, the demand parameters in one embodiment include the “base demand” “K” of M at S, the “elasticity” γ (gamma) of M at S, the “inventory effect” parameter α (alpha) of M at S, and the seasonality σₜ (sigma) of M at S. Constraints are also received.

At 204, the unknown price curve p(t) and unknown inventory curve I(t) are expressed as linear combinations of orthogonal polynomials (e.g., Chebyshev polynomials) and coefficients for the orthogonal polynomials. Price variables/coefficients pᵢ are used for p(t) and inventory variables/coefficients Iᵢ are used for I(t). As a result, revenue “R” for M selling at S over a time period [T0, T1] is a function of the pᵢ and Iᵢ coefficients. Hence, maximization of R means finding the pᵢ and Iᵢ, that make R as large as possible, thus providing the optimal p(t) and I(t).

At 206, revenue (“R”) is determined in terms of the value for the pᵢ and Iᵢ variables. In one embodiment a numerical integration is performed to find R. The integral can be replaced by a sum over the weeks between T0 and T1, where the integrand is evaluated only at week boundaries. This typically provides useful results, since retail data is usually weekly in nature (and the seasonality σₜ is weekly in any event).

At 208, “initial guesses” are determined for the pᵢ and Iᵢ variables. These can be determined by using historical data, and applying known techniques for determining orthogonal polynomial coefficients. The theory of orthogonal polynomials determines these coefficients by certain integrals. In one embodiment, as disclosed, the integrals can be reduced to sums over weekly data, since historical data at retailers is typically weekly. If a retailer has daily data, then the sums can be daily instead of weekly.

At 210, the gradient of R is determined. R is a function of the variables pᵢ and Iᵢ. The gradient can be determined by calculating

$$\frac{\partial R}{\partial {p}_{i}}$$

and

$$\frac{\partial R}{\partial {I}_{i}} .$$

These can be found by “differentiating under the integral sign”, and hence the gradient can be expressed as integrals. Further, as disclosed, the integral can be evaluated as a sum over the weeks between T0 and T1, where the integrand is only evaluated at weekly points.

At 212, the constraints are expressed in terms of constraints on the pᵢ and the Iᵢ. Because these are the variables over which the revenue is being maximized, the constraints are in terms of these variables as well.

At 214, the revenue is maximized using as input the revenue function from R from 206, the initial guesses of the pᵢ and Iᵢ coefficients from 208, the gradient of R from 210, and the constraints from 212. The maximization can be performed using standard known maximization software products. As a result, the values for pᵢ and Iᵢ are determined.

At 216, from the values pᵢ and Iᵢ at 214 the functions p(t) and I(t) are obtained, and hence the price markdown recommendations/schedule and inventory schedule is determined. These can now be used in price-management and inventory-management software to give optimal management of price and associated optimal management of inventory relative to those optimal prices. For example, in a software system for generating markdown recommendations to retailers, the function p(t) becomes the markdown recommendations given to the retailer. In one embodiment, the price markdown schedule involves discrete price and time so that the prices are selected from a pricing ladder. In this embodiment, the prices given by the function p(t) may have to be rounded to the nearest price in the price ladder (e.g., if p(t) is recommending $3.34 as the price, the nearest price on the price ladder may actually be $3.50, and thus the retailer should use $3.50 instead of $3.34).

In one embodiment, the maximization at 214 is done on a periodic (e.g., on a weekly basis), because the system that generates markdown recommendations updates base demand (K) and seasonality (σₜ) periodically. Since base demand and seasonality are inputs to the whole maximization process, the maximization is rerun, to obtain an updated p(t) and I(t). On the basis of the new p(t) and I(t), the system then makes updated recommendations for markdowns to the retailer.

As disclosed, embodiments provide markdown pricing optimization while accounting for inventory effects. Embodiments can be used to maximize revenue over a larger variety of constraints. Other approaches to markdown optimization are “analytical,” in that they require being able to mathematically handle the constraint using the “calculus of variations.” In contrast, embodiments of the present invention may be more widely applicable, since they function if the constraints are expressed in terms of Chebyshev polynomials or other types of orthogonal polynomials.

Several embodiments are specifically illustrated and/or described herein. However, it will be appreciated that modifications and variations of the disclosed embodiments are covered by the above teachings and within the purview of the appended claims without departing from the spirit and intended scope of the invention.

What is claimed is:

1. A computer readable medium having instructions stored thereon that, when executed by a processor, cause the processor to determine a pricing markdown schedule for a retail item at a store, the pricing markdown determination comprising:
receive demand parameters of the retail item at the store and one or more constraints;
express a price curve and inventory curve as linear combinations of price and inventory coefficients for orthogonal polynomials;
determine a revenue in terms of values of the price and inventory coefficients;
determine an initial guess of the price and inventory coefficients;
determine a gradient of the revenue;
maximize the revenue based on the revenue, the initial guesses, the gradient, and the constraints, wherein the constraints are in terms of the price and inventory coefficients; and
based on the maximized revenue, generate the price markdown schedule.

2. The computer readable medium of claim 1, wherein the orthogonal polynomials comprise Chebyshev polynomials.

3. The computer readable medium of claim 1, further comprising:
based on the maximized revenue, generate an inventory schedule.

4. The computer readable medium of claim 1, wherein the initial guesses are based on historical data.

5. The computer readable medium of claim 1, wherein the constraints comprise at least one of an equality constraint or an inequality constraint.

6. The computer readable medium of claim 5, wherein the equality constraint comprises at least one of a point wise equality constraint or a functional equality constraint.

7. The computer readable medium of claim 5, wherein the inequality constraint comprises at least one of a point wise inequality constraint or a functional inequality constraint.

8. The computer readable medium of claim 1, further comprising rounding a price on the price markdown schedule to a price ladder.

9. A computer implemented method for determining a pricing markdown schedule for an item at a store, the pricing markdown determination comprising:
receiving demand parameters of the item at the store and one or more constraints;
expressing a price curve and inventory curve as linear combinations of price and inventory coefficients for orthogonal polynomials;
determining a revenue in terms of values of the price and inventory coefficients;
determining an initial guess of the price and inventory coefficients;
determining a gradient of the revenue;
maximizing the revenue based on the revenue, the initial guesses, the gradient, and the constraints, wherein the constraints are in terms of the price and inventory coefficients; and
based on the maximized revenue, generating the price markdown schedule.

10. The computer implemented method of claim 9, wherein the orthogonal polynomials comprise Chebyshev polynomials.

11. The computer implemented method of claim 9, further comprising:
based on the maximized revenue, generating an inventory schedule.

12. The computer implemented method of claim 9, wherein the initial guesses are based on historical data.

13. The computer implemented method of claim 9, wherein the constraints comprise at least one of an equality constraint or an inequality constraint.

14. The computer implemented method of claim 13, wherein the equality constraint comprises at least one of a point wise equality constraint or a functional equality constraint.

15. The computer implemented method of claim 13, wherein the inequality constraint comprises at least one of a point wise inequality constraint or a functional inequality constraint.

16. A retail product pricing markdown system comprising:
a coefficient module that receives demand parameters of a retail item at a store and one or more constraints, and expresses a price curve and inventory curve as linear combinations of price and inventory coefficients for orthogonal polynomials;
a determination module that determines a revenue in terms of values of the price and inventory coefficients, determines an initial guess of the price and inventory coefficients, and determines a gradient of the revenue;
a maximize module that maximizes the revenue based on the revenue, the initial guesses, the gradient, and the constraints, wherein the constraints are in terms of the price and inventory coefficients; and
a generator module that, based on the maximized revenue, generates the price markdown schedule.

17. The system of claim 16, wherein the orthogonal polynomials comprise Chebyshev polynomials.

18. The system of claim 16, the generator module, based on the maximized revenue, further generates an inventory schedule.

19. The system of claim 16, wherein the initial guesses are based on historical data.

20. The system of claim 16, wherein the constraints comprise at least one of an equality constraint or an inequality constraint.
